(19) United States
(12) Patent Application Publication
(10) Pub. No.: US 2023/0303870 A1
(43) Pub. Date: Sep. 28, 2023

(54) AQUEOUS INKJET INK FOR TEXTILE PRINTING AND METHOD FOR PRODUCING PRINTED TEXTILE ITEM

(71) Applicant: RISO KAGAKU CORPORATION, Tokyo (JP)

(72) Inventors: Tetsuya SHIRAISHI, Tokyo (JP); Akiko HAYASHI, Tokyo (JP); Kokoro KINOE, Tokyo (JP)

(21) Appl. No.: 18/187,106

(22) Filed: Mar. 21, 2023

(30) Foreign Application Priority Data
Mar. 28, 2022 (JP) 2022-051810

(51) Int. Cl. C09D 11/322; C09D 11/38; C09D 11/326; C09D 11/104; C09D 11/023

(52) U.S. Cl. CPC C09D 11/322; C09D 11/38; C09D 11/326; C09D 11/104; C09D 11/023

(57) ABSTRACT

An aqueous inkjet ink for textile printing is disclosed which contains water, a water-soluble organic solvent, an amino alcohol, a water-dispersible resin, and a pigment, and in which an amount of a solid fraction of the ink relative to a total mass of the ink is at least 20% by mass; and the water-soluble organic solvent contains a water-soluble organic solvent (A) which has a boiling point of at least 250° C. and is one or more compounds selected from the group consisting of polyalkylene glycols, polyalkylene glycol derivatives, and trihydric alcohols. A method for producing a printed textile item is also disclosed.

### CROSS REFERENCE TO RELATED APPLICATIONS

This application is based upon and claims the benefit of priority from the prior Japanese Patent Application No. 2022-051810, filed on Mar. 28, 2022, the entire contents of which are incorporated by reference herein.

### BACKGROUND OF THE INVENTION

### Field of the Invention

Embodiments of the present invention relate to an aqueous inkjet ink for textile printing and a method for producing a printed textile item.

### Description of the Related Art

Among various methods for printing images such as text, pictures, or designs onto fabrics such as woven fabrics, knitted fabrics, and nonwoven fabrics, in addition to screen textile printing methods and roller textile printing methods, direct-type inkjet textile printing methods are attracting considerable attention in recent years. By means of the direct-type inkjet textile printing methods, it is possible to process images using a computer and print images in a substantially plate-less manner. The inkjet textile printing methods also have the advantage of having wider applicability than other textile printing methods in that images can be printed on fabric s in a non-contact manner. For textile printing on fabrics, an aqueous inkjet ink is suitable from the viewpoint of preventing deterioration in the fabric due to a solvent and environmental safety.

In textile printing on fabrics, if a pigment with excellent color development properties and weather resistance for images is used, a pigment that exhibits binding properties and a resin that enhances the fixability between the pigment and the fabric are used to enhance the fixation of the pigment to the fabric. The addition of a binder resin can enhance the fixation of the ink image on the fabric and further enhance the coating film strength of the ink image, for example.

If the amount of solid fractions such as pigments and resins increases for the fixation of the ink image on the fabric, the ink may solidify or turn into a film when the ink is left in an open-air environment. If an ink mist adheres to the vicinity of a nozzle jetting port when the ink is jetted from an inkjet nozzle, for example, the adhered ink in the vicinity of the nozzle jetting port may be exposed to the atmosphere and solidify or turn into a film. This may cause a jetting failure. It is also possible to wipe off the adhered ink in the vicinity of the nozzle jetting port with a wiping action, but if the ink has solidified or formed into a film, the wipability may deteriorate.

As a method for preventing the solidification or film formation of an aqueous ink, there is a method to suppress the vaporization of moisture from an aqueous ink by adding a moisture-retaining component such as glycerol to the aqueous ink. The relationship between the addition of amine compounds to the aqueous ink and the solidification or film formation of the ink has also been studied.

JP 2010-053328 A discloses that, in printing on a positively charged overhead projector sheet (an OHP sheet), by using an anionic urethane resin as a fixing resin of an aqueous ink, the fixation of an ink image is enhanced.

JP 2010-053328 A discloses the use of a polyalcohol such as glycerol to suppress drying of the ink in an aqueous ink.

JP 2016-210954 A discloses that the abrasion resistance of images and maintainability are improved by using an aqueous ink containing an anionic urethane resin in printing on a glossy paper. JP 2016-210954 A discloses that, in an aqueous ink, if a specific amine compound is contained at a specific mass ratio relative to an anionic urethane resin, a viscosity rise of the ink is suppressed because even when water vaporizes from the aqueous ink, the amine compound remains in the aqueous ink and acts as counter ions of the anionic urethane resin.

### SUMMARY OF THE INVENTION

One aspect of the present invention provides an aqueous inkjet ink for textile printing including water, a water-soluble organic solvent, an amino alcohol, a water-dispersible resin, and a pigment, in which a solid fraction of the ink relative to a total amount of the ink is at least 20% by mass; the water-soluble organic solvent contains a water-soluble organic solvent (A) which has a boiling point of at least 250° C. and is one or more compounds selected from the group consisting of polyalkylene glycols, polyalkylene glycol derivatives, and a trihydric alcohols; an amount of the water-soluble organic solvent (A) relative to the total amount of the ink is 1 to 7% by mass; if an amount obtained by excluding an amount of the amino alcohol from a total amount of the water-soluble organic solvent is 1 part by mass, an amount of the water-soluble organic solvent (A) is at least 0.110 parts by mass; and if a total amount of the solid fraction of the ink is 1 part by mass, an amount of the amino alcohol is at least 0.010 parts by mass.

Another aspect of the present invention provides a method for producing a printed textile item including: applying the aqueous inkjet ink for textile printing described above to a fabric by means of an inkjet method.

### DETAILED DESCRIPTION OF THE EMBODIMENTS

The present invention will be described below using embodiments. The invention is not limited by the exemplifications in the following embodiments. The terms and expressions in the following description are not limited by specific examples of the Examples described below.

### <Aqueous Inkjet Ink for Textile Printing>

As in the techniques disclosed in JP 2010-053328 A and JP 2016-210954 A, the aqueous ink applied to the OHP sheet, glossy paper, or the like has a low amount of solid fraction and a relatively high amount of water. For this reason, the formulation of the ink allows a certain amount of moisture to vaporize from the ink in an open, unattended environment. If the total amount of solid fraction such as pigments and resins is high in order to enhance the image density and fixation of an ink image in textile printing on a fabric, there are problems that if moisture vaporizes from the ink, the stability of the system breaks down, the pigments, resins, and the like aggregate, and further the aggregated pigments, resins, and the like easily adhere.

In the technique disclosed in JP 2010-053328 A, the content ratio of glycerol, which is a moisture-retaining component, is increased to suppress drying of the ink and prevent clogging of an inkjet nozzle. However, if the aqueous ink containing a large amount of the moisture-retaining component is applied to a fabric, it becomes difficult for the solvent components to dry out from the fabric, the solvent components wet-spread outside the image area, and solvent bleeding may be observed around the ink image.

In the technique disclosed in JP 2016-210954 A, an amine compound is added to the ink to prevent aggregation due to the volatilization of counter ions of the solid faction. However, if the ink has a high amount of solid fraction and a low amount of water, the change in the polarity of the solvent system when the water vaporizes from the ink becomes large, which may cause aggregation of pigments, resins, and the like.

An aqueous inkjet ink for textile printing according to one embodiment contains water, a water-soluble organic solvent, amino alcohol, a water-dispersible resin, and a pigment, in which an amount of a solid fraction relative to the total amount of the ink is at least 20% by mass; the water-soluble organic solvent contains a water-soluble organic solvent (A) which has a boiling point of at least 250° C. and is one or more compounds selected from the group consisting of polyalkylene glycols, polyalkylene glycol derivatives, and trihydric alcohols; the amount of the water-soluble organic solvent (A) relative to the total amount of the ink is 1 to 7% by mass; if the amount obtained by excluding the amount of the amino alcohol from the total amount of the water-soluble organic solvent is 1 part by mass, the amount of the water-soluble organic solvent (A) is at least 0.110 parts by mass; and if the total amount of the solid fraction is 1 part by mass, the amount of the amino alcohol is at least 0.010 parts by mass.

According to one embodiment, it is possible to provide an aqueous inkjet ink for textile printing that has excellent ink wiping properties and can suppress solvent bleeding of a printed textile item.

In the following description, the aqueous inkjet ink for textile printing is sometimes simply referred to as an aqueous ink or an ink.

In the aqueous ink, particulate matter such as a pigment and resin particles is preferably in a dispersed state due to electrostatic repulsion. Counter ions are included in the aqueous ink to assist the electrostatic repulsion of the particulate matter. The counter ions are generally blended into the aqueous ink as ionic compounds having a low boiling point. Therefore, if the aqueous ink is left in an open-air environment, the ionic compounds having a low boiling point easily volatilize from the ink together with moisture. If the ionic compounds volatilize and the number of counter ions in the ink decreases, the electrostatic repulsion between the particulate matter weakens, and the particulate matter is likely to aggregate. If the amount of the solid fraction of the ink relative to the total amount of the ink is at least 20% by mass, it is desirable that the counter ions are sufficiently contained in the aqueous ink to obtain the auxiliary effect of the electrostatic repulsion.

Since amino alcohol is a compound with a relatively high boiling point, if the amino alcohol is contained in the aqueous ink, volatilization from the ink can be suppressed even in an open, unattended environment. Since an amino group is cationic, the amino alcohol can act as the counter ions of the particulate matter in the aqueous ink and assist the electrostatic repulsion of the particulate matter. In addition, since the amino alcohol is an organic substance, the amino alcohol has a high affinity with a water-soluble organic solvent, and therefore the amino alcohol easily acts as the counter ions of the particulate matter in the aqueous ink. In this way, the amino alcohol can assist the electrostatic repulsion of the particulate matter and suppress the aggregation of the particulate matter.

Suppose that, in a state where the particulate matter tends to aggregate due to a reduction in counter ions, the aqueous ink is jetted from an inkjet nozzle and an ink mist adheres to the vicinity of a nozzle jetting port. In this case, the particulate matter of the ink may adhere to the vicinity of the nozzle jetting port, and a jetting failure of the nozzle may be caused. In addition, it becomes difficult for the particulate matter stuck in the vicinity of the nozzle jetting port to be removed by a wiping operation of the printing device, and this may cause a decrease in the wiping properties of the ink. If the wiping properties decrease, it becomes difficult to improve the jetting failure, and furthermore, the life of members such as wipers is shortened and the maintainability of the printing device may be reduced.

The water-soluble organic solvent (A) contained in the aqueous ink has a boiling point of at least 250° C. and is one or more compounds selected from the group consisting of polyalkylene glycols, polyalkylene glycol derivatives, and trihydric alcohols. Therefore, the water-soluble organic solvent (A) exhibits a high boiling point and high polarity, and tends to be less volatile from the aqueous ink, and furthermore, the water-soluble organic solvent (A) tends to exhibit a moisture-retaining property and can suppress the volatilization of moisture from the aqueous ink.

Meanwhile, if the aqueous ink is applied to a fabric, the water-soluble organic solvent (A) tends to be less volatile from the printed textile item and the volatilization of moisture may be suppressed. This may be a cause for the occurrence of solvent bleeding of the printed textile item. Solvent bleeding is a phenomenon in which the solvent component bleeds out from an ink-applied area of a printed textile item and discoloration of the substrate due to the solvent is observed around the ink image.

When the amount of the water-soluble organic solvent (A) relative to the total amount of the ink is in a specified range, it is possible to suppress the vaporization of moisture and also to suppress solvent bleeding in a printed textile item.

In embodiments herein, if the amount obtained by excluding the amount of the amino alcohol from the total amount of the water-soluble organic solvent is 1 part by mass, the amount of the water-soluble organic solvent (A) is at least 0.110 parts by mass. This can increase the mass ratio of the water-soluble organic solvent (A) having a high boiling point and high polarity in a solvent system. The water-soluble organic solvent (A) exhibits a high boiling point and tends to be less volatile from the aqueous ink even in an open, unattended environment. Therefore, even if water vaporizes and decreases, the decrease in the water-soluble organic solvent (A) may be suppressed, and the solvent system can be maintained at a high polarity. If the polarity of the solvent system is decreased, poor dispersion of particulate matter, especially hydrophilic particulate matter, may be caused. Therefore, by maintaining the solvent system at a high polarity, the aggregation of the particulate matter can be suppressed, and the deterioration in the ink wiping properties can be prevented.

The amino alcohol may act as the counter ions of the particulate matter in the aqueous ink. Therefore, when the mass ratio of the amino alcohol relative to the solid fraction containing the particulate matter is within a specified range, it is possible to sufficiently maintain the electrostatic repulsion of the particulate matter in the aqueous ink, suppress the aggregation of the particulate matter, and prevent the deterioration in the ink wiping properties.

The aqueous ink contains water, a water-soluble organic solvent, an amino alcohol, a water-dispersible resin, and a pigment, and the amount of a solid fraction of the ink relative to the total amount of the ink is at least 20% by mass. The amount of the solid fraction of the aqueous ink is the total amount of components excluding volatile components. Examples of the solid fraction of the aqueous ink include pigments and water-dispersible resins, and further include nonvolatile components among optional components such as pigment dispersants, surfactants, and crosslinking agents. With respect to the method for measuring the amount of the solid fraction of the aqueous ink, the amount of the solid fraction can be obtained by means of thermal analysis such as TG-DTA (differential thermogravimetric analysis). Specifically, the amount of the solid fraction of the aqueous ink is the total amount of the components remaining when the temperature is raised to 500° C. under a nitrogen atmosphere with a “Thermo plus EV02” (product name) manufactured by Rigaku Corporation.

If the amount of the solid fraction relative to the total amount of the aqueous ink is at least 20% by mass, the pigment concentration in the ink increases and the image density of the printed textile item can be enhanced. In addition, if resin particle s are included in the solid fraction, a resin coating film can be formed on the printed textile item and the fixation of the ink image can be further enhanced. In addition, by forming the resin coating film on the printed textile item, the coating film strength of the ink image can be increased, and the abrasion resistance and robustness of the printed textile item can be further enhanced. In one embodiment, since the electrostatic repulsion of the particulate matter such as a pigment can be sufficiently maintained, the deterioration in ink wiping properties can be prevented even if the amount contained of the solid fraction relative to the total amount of the aqueous ink is at least 23% by mass or at least 25% by mass.

Although the amount of the solid fraction relative to the total amount of the aqueous ink not particularly limited, from the viewpoint of preventing the ink from becoming highly viscous and enhancing the jetting performance, the amount of the solid fraction relative to the total amount of the aqueous ink is preferably not more than 40% by mass, more preferably not more than 35% by mass, and even more preferably not more than 30% by mass. If the amount of the solid fraction is within these ranges, the solid fraction can be appropriately adjusted in consideration of the image density, application, texture, and the like of the printed textile item while suppressing the aggregation of the solid fraction including a pigment and resin particles.

The amount of the solid fraction relative to the total amount of the ink may be 20 to 40% by mass, 23 to 35% by mass, or 25 to 30% by mass, for example.

The aqueous ink contains the water-soluble organic solvent (A). The water-soluble organic solvent (A) may have a boiling point of at least 250° C. and be one or more compounds selected from the group consisting of polyalkylene glycols, polyalkylene glycol derivatives, and trihydric alcohols.

If the amount of the water-soluble organic solvent (A) relative to the total amount of the ink is at least 1% by mass, the moisture-retaining property of the aqueous ink can be sufficiently obtained, and the volatilization of moisture can be suppressed in an open, unattended environment. Since a decrease in polarity of the aqueous ink due to a decrease in moisture can be prevented, the aggregation of particulate matter can be suppressed, and a decrease in the ink wiping properties can be prevented. The ink wiping properties can be improved from the viewpoint that the thickening of the aqueous ink can be suppressed by suppressing the volatilization of moisture from the aqueous ink. More preferably, the amount of the water-soluble organic solvent (A) relative to the total amount of the ink is at least 3% by mass, and even more preferably at least 4% by mass.

If the amount of the water-soluble organic solvent (A) relative to the total amount of the ink is not more than 7% by mass, it is possible to prompt the volatilization of water and a water-soluble organic solvent on the surface of the printed textile item and prevent the occurrence of solvent bleeding of the printed textile item. From the viewpoint of greater prevention of solvent bleeding of the printed textile item, the amount of the water-soluble organic solvent (A) relative to the total amount of the ink may be not more than 6% by mass or not more than 5% by mass.

The amount of the water-soluble organic solvent (A) relative to the total amount of the ink may be 1 to 7% by mass, 3 to 6% by mass, or 4 to 7% by mass, for example.

If the amount obtained by excluding the amount of the amino alcohol from the total amount of the water-soluble organic solvent is 1 part by mass, the amount of the water-soluble organic solvent (A) is preferably at least 0.110 parts by mass, more preferably at least 0.120 parts by mass, even more preferably at least 0.130 parts by mass, and still even more preferably at least 0.150 parts by mass. If the amount is within these ranges, it is possible to suppress the aggregation of the particulate matter in the aqueous ink and prevent the deterioration in the ink wiping properties.

If the amount obtained by excluding the amount of the amino alcohol from the total amount of the water-soluble organic solvent is 1 part by mass, the amount of the water-soluble organic solvent (A) is not particularly limited but is preferably not more than 0.650 parts by mass, more preferably not more than 0.550 parts by mass, and even more preferably not more than 0.450 parts by mass. If the amount is within these ranges, the occurrence of solvent bleeding in the printed textile item can be prevented to a greater extent. From the viewpoint of greater prevention of solvent bleeding of the printed textile item, the mass ratio of the water-soluble organic solvent (A) is more preferably not more than 0.400 parts by mass, or not more than 0.300 parts by mass.

If the amount obtained by excluding the amount of the amino alcohol from the total amount of the water-soluble organic solvent is 1 part by mass, the amount of the water-soluble organic solvent (A) may be 0.110 to 0.650 parts by mass, 0.120 to 0.550 parts by mass, or 0.130 to 0.450 parts by mass, for example.

When the total amount of the solid fraction is 1 part by mass, the amount of amino alcohol is preferably at least 0.010 parts by mass, more preferably at least 0.020 parts by mass, and even more preferably at least 0.035 parts by mass. If the amount is within these ranges, it is possible to suppress the aggregation of the particulate matter in the aqueous ink and prevent the decrease in wiping properties.

When the total amount of the solid fraction is 1 part by mass, the amount of amino alcohol is not particularly limited but is preferably not more than 0.200 parts by mass, more preferably not more than 0.150 parts by mass, and even more preferably not more than 0.080 parts by mass. If the amount is within these ranges, even if amino alcohol having a high viscosity is used, a viscosity rise of the aqueous ink can be suppressed. In addition, the pH range of the aqueous ink can be appropriately adjusted and the ink storage stability can be further enhanced.

In this way, when the aqueous ink contains the amino alcohol and water-soluble organic solvent (A), the amount of solid fraction relative to the total amount of the ink is at least 20% by mass, the amount of the water-soluble organic solvent (A) relative to the total amount of the ink is specified, the mass ratio of the water-soluble organic solvent (A) relative to the solvent system is specified, and the mass ratio of the amino alcohol relative to the solid fraction is specified, it is possible to provide an aqueous inkjet ink for textile printing which has excellent ink wiping properties and can suppress solvent bleeding of the printed textile item.

The amino alcohol will be described below.

The amino alcohol may be either an aliphatic amine having a hydroxy group or an aromatic amine having a hydroxy group, and may be a combination of these, but is preferably an aliphatic amine having a hydroxy group. The aliphatic amine having a hydroxy group may be a compound containing an amino group and a saturated or unsaturated, linear or branched hydrocarbon group, in which at least one hydrogen atom of the hydrocarbon group is substituted with a hydroxy group, but alkanolamine is especially preferred. In the amino alcohol, the number of hydroxy groups is preferably 1 to 5, more preferably 1 to 4, and even more preferably 1 to 3.

The amino alcohol may be a monoamine, a polyamine such as a diamine or triamine, or a combination thereof. From the viewpoint of the adjustment of basicity, the amino alcohol is preferably a monoamine, and especially preferably an alkanol monoamine. From the viewpoint of the adjustment of solubility and basicity, the amino alcohol is preferably a compound that does not contain heteroatoms except for nitrogen atoms and oxygen atoms in the hydroxy group.

The amino alcohol may be any one of a primary amine compound, a secondary amine compound, and a tertiary amine compound, and combinations of these may be used.

Examples of the amino alcohol include 2,2′,2″-nitrilotriethanol, di-2-propanolamine, 2-dimethylethanolamine, 2-amino-2-methyl-1-propanol, 1-amino-2-propanol, 3-amino-1-propanol, N-methylethanolamine, N,N-dimethylethanolamine, 1-amino-2-methyl-propanol, monoethanolamine, diethanolamine, triethanolamine, N,N-dimethyl monoethanolamine, trishydroxymethylaminomethane, N-methyldiethanolamine, N-methylethanolamine, N-phenylethanolamine, 3-aminopropyldiethylamine, and 2-amino-2-ethyl-1,3-propanediol. Among them, di-2-propanolamine and triethanolamine are preferred.

The boiling point of the amino alcohol is not particularly limited, but from the viewpoint of making the ink less volatile and less viscous, the boiling point is preferably 100 to 400° C., more preferably 130 to 360° C., and even more preferably 150 to 350° C. From the viewpoint of contribution to the ink wiping properties by suppressing the volatilization of the amino alcohol from the aqueous ink, the boiling point of the amino alcohol is preferably at least 100° C., at least 130° C., or at least 150° C., and may be at least 200° C., at least 250° C., or at least 300° C.

The amino alcohol is preferably a water-soluble compound, and is preferably a compound at least 0.1 g, at least 1 g, or at least 5 g of which is dissolved in 100 g of water at 25° C., for example. In the formulation of the aqueous ink, the amino alcohol is preferably dissolved in the water and water-soluble organic solvent of the aqueous ink at 25° C.

The aqueous ink preferably contains water, and the main solvent may be water. There are no particular limitations on the water, but water containing as few ionic components as possible is preferred. In particular, from the viewpoint of storage stability of the aqueous ink, the amount of polyvalent metal ions such as calcium ions is preferably kept low. Examples of the water include ion-exchanged water, distilled water, and ultrapure water.

From the viewpoint of ink viscosity adjustment, the amount of water relative to the total amount of aqueous ink is preferably 20 to 80% by mass, more preferably 40 to 70% by mass, and even more preferably 50 to 60% by mass.

The aqueous ink preferably contains a water-soluble organic solvent. Organic compounds that are liquids at room temperature (25° C.) and can be dissolved in water can be used as the water-soluble organic solvent, and the use of a water-soluble organic solvent that mixes uniformly with an equal volume of water at 1 atmosphere and 20° C. is preferred.

The water-soluble organic solvent (A) will be described below.

Since the water-soluble organic solvent (A) has a boiling point of at least 250° C., the volatilization of the water-soluble organic solvent (A) from the aqueous ink can be suppressed, the moisture-retaining property of the aqueous ink can be enhanced, the aggregation of the particulate matter caused by the decrease in polarity due to the decrease in water content of the aqueous ink can be suppressed, and accordingly the decrease in the ink wiping properties can be prevented. More preferably, the boiling point of the water-soluble organic solvent (A) is at least 260° C., and even more preferably at least 280° C.

Although the boiling point of the water-soluble organic solvent (A) is not particularly limited, from the viewpoint of the viscosity adjustment of the aqueous ink, the boiling point is preferably not more than 400° C., not more than 350° C., or not more than 300° C.

The boiling point of the water-soluble organic solvent (A) may be 250 to 400° C., 260 to 350° C., or 280 to 300° C., for example.

The water-soluble organic solvent (A) is one or more compounds selected from the group consisting of polyalkylene glycols, polyalkylene glycol derivatives, and trihydric alcohols.

Examples of the polyalkylene glycol include polyethylene glycol, polypropylene glycol, polyethylene/propylene glycol, and polytrimethylene glycol. From the viewpoint of adjusting the boiling point of the solvent and the viscosity of the ink, the number-average molecular weight of the polyalkylene glycol is preferably 100 to 800 and more preferably 150 to 400. The number-average molecular weight is a value obtained by a gel permeation chromatography (GPC) method in terms of standard polystyrene.

Specific examples of polyalkylene glycol having a boiling point of at least 250° C. include triethylene glycol, tetraethylene glycol, polyethylene glycol, tripropylene glycol, and polypropylene glycol.

Examples of the polyalkylene glycol derivatives include polyalkylene glycol monoalkyl ethers and polyalkylene glycol dialkyl ethers. Examples also include monoalkyl ethers or dialkyl ethers of, for example, polyethylene glycol, polypropylene glycol, polyethylene/propylene glycol, and polytrimethylene glycol.

Specific examples of polyalkylene glycol derivatives exhibiting a boiling point of at least 250° C. include triethylene glycol monoethyl ether, triethylene glycol monopropyl ether, triethylene glycol monobutyl ether, tetraethylene glycol monomethyl ether, tetraethylene glycol monoethyl ether, tetraethylene glycol dimethyl ether, and tetraethylene glycol diethyl ether.

The trihydric alcohol is preferably saturated or unsaturated aliphatic trihydric alcohol and more preferably saturated aliphatic trihydric alcohol. The carbon number of the trihydric alcohol is preferably 3 to 8 and more preferably 2 to 5.

Specific examples of trihydric alcohols exhibiting a boiling point of at least 250° C. include glycerol, trimethylolethane, and 1,2,4-butanetriol.

The water-soluble organic solvent (A) is preferably glycerol, triethylene glycol, tripropylene glycol or polyethylene glycol, more preferably glycerol or triethylene glycol, and a combination thereof may be used.

The aqueous ink may further contain one or more other water-soluble organic solvents in addition to the water-soluble organic solvent (A). Examples of other water-soluble organic solvents include lower alcohols, glycols, glycol ethers, β-thiodiglycol, sulfolane, polyalkylene glycols and derivatives thereof with a boiling point of less than 250° C., and trihydric alcohols and derivatives thereof with a boiling point of less than 250° C., and from thereamong glycols and glycol ethers are preferred.

Examples of the lower alcohols include methanol, ethanol, 1-propanol, isopropanol, 1-butanol, 2-butanol, isobutanol, and 2-methyl-2-propanol. Examples of the glycols include ethylene glycol, diethylene glycol, 1,3-propanediol, 1,3-butanediol, 3-methyl-1,3-butanediol, 3-ethyl-1,3-butanediol, propylene glycol, and dipropylene glycol. Examples of the glycol ethers include ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether, diethylene glycol monobutyl ether, and triethylene glycol monomethyl ether.

The boiling point of these other water-soluble organic solvents is preferably at least 100° C., and more preferably at least 150° C. One of these other water-soluble organic solvents may be used alone or a combination of two or more of these other water-soluble organic solvents may be used provided that the solvents form a single phase with water and the water-soluble organic solvent (A).

In addition to the water-soluble organic solvent (A), the aqueous ink preferably further contains a water-soluble organic solvent (B) having a boiling point of less than 250° C. as a water-soluble organic solvent. This can further suppress the occurrence of solvent bleeding in a printed textile item.

The boiling point of the water-soluble organic solvent (B) is more preferably not more than 245° C., and even more preferably not more than 230° C.

Although not particularly limited, the boiling point of the water-soluble organic solvent (B) is preferably at least 100° C., at least 150° C., or at least 200° C. from the viewpoint of making the ink low volatile.

The boiling point of the water-soluble organic solvent (B) may be 100 to 250° C., 150 to 245° C., or 200 to 230° C., for example.

As the water-soluble organic solvent (B), a single solvent with a boiling point of less than 250° C. may be used or a combination of two or more water-soluble organic solvents with a boiling point of less than 250° C. may be used among the specific examples of the water-soluble organic solvents described above. Glycols are preferred as the water-soluble organic solvent (B). Examples of the water-soluble organic solvent (B) include diethylene glycol, 1,3-butanediol, 3-methyl-1,3-butanediol, 2-ethyl-1,3-hexanediol, dipropylene glycol, 1,3-propanediol, 1,3-butanediol, 3-methyl-1,3-butanediol, and 3-ethyl-1,3-butanediol. The water-soluble organic solvent (B) is preferably diethylene glycol, dipropylene glycol, 1,3-propanediol or 1,3-butanediol, and one of them may be used alone or a combination of two or more may be used.

If the amount obtained by excluding the amount of the amino alcohol from the total amount of the water-soluble organic solvent is 1 part by mass, the amount of the water-soluble organic solvent (B) is preferably at least 0.500 parts by mass, more preferably at least 0.600 parts by mass, and even more preferably at least 0.800 parts by mass from the viewpoint of suppressing the occurrence of solvent bleeding in the printed textile item. The mass ratio of the water-soluble organic solvent (B) may be 0.500 to 0.900 parts by mass, 0.600 to 0.880 parts by mass, or 0.800 to 0.850 parts by mass. From the viewpoint of further suppressing the occurrence of solvent bleeding in the printed textile item, it is preferable that all of the water-soluble organic solvents contained in the aqueous ink, except for the water-soluble organic solvent (A) and the amino alcohol, have a boiling point of less than 250° C.

The amount of the water-soluble organic solvent (B) relative to the total amount of the ink may be 1 to 80% by mass, more preferably 5 to 50% by mass, 10 to 30% by mass, or 15 to 20% by mass.

If the ink contains one or more other water-soluble organic solvents in addition to the water-soluble organic solvent (A), the total amount contained of the water-soluble organic solvents relative to the total amount of the ink is preferably 1 to 80% by mass, more preferably 5 to 40% by mass, and even more preferably 7 to 30% by mass.

The aqueous ink can contain a pigment. The pigment may be either a white pigment or a non-white pigment.

The aqueous ink can be used to form an image that presents a white color by containing the white pigment. The ink containing the white pigment can be applied to a substrate as an underlayer for color printing to enhance the concealment properties of the substrate. The white pigment may be either an inorganic pigment or an organic pigment and combinations of theses may be used.

Examples of the white pigment include a white inorganic pigment such as titanium oxide, zinc oxide, zinc sulfide, antimony oxide, or zirconium oxide. In addition, a white organic pigment such as hollow resin fine particles or solid resin fine particles can be used. Among them, it is preferable to use a titanium oxide pigment from the viewpoint of concealment properties. From the viewpoint of concealment properties, the average particle size of the white pigment, expressed as the volume-based average value in a particle size distribution measured by means of a dynamic light scattering method, is preferably at least 50 nm, at least 100 nm, or at least 200 nm, and from the viewpoint of jetting stability, is preferably not more than 500 nm, not more than 400 nm, or not more than 300 nm. From the viewpoints of the concealment properties and jetting stability, the average particle size of the titanium oxide pigment is more preferably 200 to 300 nm. When a titanium oxide pigment is used, it is preferable to use a titanium oxide pigment that has been subjected to a surface treatment with alumina, silica, or the like to suppress a photocatalytic action. The amount of surface treatment in the pigment is preferably 5 to 20% by mass

When the aqueous ink contains a non-white pigment, a color ink may be provided. Examples of the color ink include a magenta ink, a cyan ink, a yellow ink, and a black ink. The non-white pigment may be either an inorganic pigment or an organic pigment, and combinations of these may be used.

Organic pigments such as azo pigments, phthalocyanine pigments, polycyclic pigments, and dye lake pigments, and inorganic pigments such as carbon blacks and metal oxides may be used as the non-white pigment. Examples of the azo pigments include soluble azo lake pigments, insoluble azo pigments, and condensed azo pigments. Examples of the phthalocyanine pigments include metal phthalocyanine pigments and metal-free phthalocyanine pigments. Examples of the polycyclic pigments include quinacridone-based pigments, perylene-based pigments, perinone-based pigments, isoindoline-based pigments, isoindolinone-based pigments, dioxazine-based pigments, thioindigo-based pigments, anthraquinone-based pigments, quinophthalone-based pigments, metal complex pigments, and diketopyrrolopyrrole (DPP). Examples of the carbon blacks include furnace carbon black, lamp black, acetylene black, and channel black. From the viewpoints of the jetting stability and the storage stability, the average particle size of the non-white pigment, expressed as the volume-based average value in a particle size distribution measured by means of a dynamic light scattering method, is preferably not more than 300 nm, more preferably not more than 150 nm, and even more preferably not more than 100 nm.

A self-dispersing pigment may be used as a pigment. The self-dispersing pigment is a pigment in which a hydrophilic functional group has been introduced at the pigment surface by a chemical treatment or a physical treatment. The hydrophilic functional group introduced into the self-dispersing pigment is preferably a group that has ionicity, and by charging the pigment surface either anionically or cationically, the pigment particles can be stably dispersed in water by electrostatic repulsion. Preferred anionic functional groups include carboxyl groups, sulfo groups, or phosphate groups. Preferred cationic functional groups include quaternary ammonium groups and quaternary phosphonium groups.

These hydrophilic functional groups may be bonded directly to the pigment surface, or may be bonded via another atom grouping. Examples of this other atom grouping include, but are not limited to, alkylene groups, phenylene groups, and naphthylene groups. Examples of methods for treating the pigment surface include diazotization treatments, sulfonation treatments, hypochlorous acid treatments, humic acid treatments, and vacuum plasma treatments.

Examples of products that can be used favorably as the self-dispersing pigment include the CAB-O-JET series of products manufactured by Cabot Corporation such as “CAB-O-JET 200”, “CAB-O-JET 300”, “CAB-O-JET 250C”, “CAB-O-JET 260M”, “CAB-O-JET 270”, and “CAB-O-JET 450C”, and “BONJET BLACK CW-1”, “BONJET BLACK CW-2”, “BONJET BLACK CW-3”, and “BONJET BLACK CW-4” manufactured by Orient Chemical Industries, Ltd. (wherein all of the above are product names).

A pigment dispersion in which a pigment has been dispersed in advance with a pigment dispersant may be used. Examples of commercially available pigment dispersions in which a pigment has been dispersed with a pigment dispersant include the HOSTAJET series manufactured by Clariant and the FUJI SP series manufactured by Fuji Pigment Co., Ltd. Further, as a pigment, a microencapsulated pigment obtained by coating the pigment with a resin may be used.

One pigment may be used alone or a combination of two or more may be used.

From the viewpoints of the image density and ink viscosity, the amount of the pigment relative to the total amount of the ink is preferably 0.1 to 20% by mass, more preferably 1 to 15% by mass, and even more preferably 2 to 10% by mass.

If a pigment is a white pigment, from the viewpoint of fabric-concealment properties, the amount of the white pigment relative to the total amount of the ink is preferably 3 to 30% by mass, more preferably 5 to 20% by mass, and even more preferably 7 to 15% by mass.

Pigment dispersants typified by polymer dispersants and surfactant-type dispersants can be used to stably disperse a storage stable pigment in a storage stable ink.

Examples of commercially available products of the polymer dispersants include the TEGO Dispers series of products such as “TEGO Dispers 740W”, “TEGO Dispers 750W”, “TEGO Dispers 755W”, “TEGO Dispers 757W”, and “TEGO Dispers 760W” manufactured by Evonik Industries AG, the Solsperse series of products such as “Solsperse 20000”, “Solsperse 27000”, “Solsperse 41000”, “Solsperse 41090”, “Solsperse 43000”, “Solsperse 44000”, and “Solsperse 46000” manufactured by The Lubrizol Corporation, the Joncryl series of products such as “Joncryl 57”, “Joncryl 60”, “Joncryl 62”, “Joncryl 63”, “Joncryl 71”, and “Joncryl 501” manufactured by BASF Japan Ltd., as well as “DISPERBYK-102”, “DISPERBYK-185”, “DISPERBYK-190”, “DISPERBYK-193”, and “DISPERBYK-199” manufactured by BYK-Chemie Japan K.K., and “Polyvinylpyrrolidone K-30” and “Polyvinylpyrrolidone K-90” manufactured by DKS Co., Ltd. (wherein all of the above are product names).

Examples of the surfactant-type dispersants include anionic surfactants, including the DEMOL series of products such as “DEMOL P”, “DEMOL EP”, “DEMOL N”, “DEMOL RN”, “DEMOL NL”, “DEMOL RNL”, and “DEMOL T-45” manufactured by Kao Corporation, and nonionic surfactants including the EMULGEN series of products such as “EMULGEN A-60”, “EMULGEN A-90”, “EMULGEN A-500”, “EMULGEN B-40”, “EMULGEN L-40”, and “EMULGEN 420” manufactured by Kao Corporation (wherein all of the above are product names).

Further, examples of the surfactant-type dispersants include “Solsperse 27000” (product name) manufactured by The Lubrizol Corporation; “Borchi Gen DFN (an aryl alkyl biphenylol polyglycol ether)” (product name) manufactured by Borchers Inc.; “DISPERBYK-193” (product name) manufactured by BYK-Chemie Japan K.K.; and “Pionin D-6115 (aryl phenyl ether)”, “Takesurf D-6108-W (polyoxyalkylene polystyryl phenyl ether)”, and “Pionin D-6512 (polyoxyethylene polystyrylphenyl ether)” manufactured by Takemoto Oil & Fat Co., Ltd., (wherein all of the above are product names).

One pigment dispersant may be used alone or a combination of two or more may be used.

When used, there are no particular limitations on the amount of the pigment dispersant in the ink, which varies depending on the type of pigment dispersant used, but generally the amount of the pigment dispersant, expressed as a mass ratio of the active component relative to a value of 1 for the pigment, is preferably 0.005 to 0.5.

The aqueous ink may contain a water-dispersible resin. Examples of the water-dispersible resins include binder resins. When the aqueous ink contains a binder resin, a resin coating film may be formed on the fabric, and accordingly, the fixation, abrasion resistance, and the like of the ink image can be enhanced.

The water-dispersible resin is preferably blended into the aqueous ink in the form of a water-in-oil emulsion, and is dispersible in the form of resin particles in the aqueous ink. The water-dispersible resin may be a self-emulsifying resin having introduced thereto hydrophilic groups and/or hydrophilic segments that enable stable dispersion in water, or may be a resin having self-dispersibility through use of a separate emulsifier. The water-dispersible resin is preferably a resin that forms a transparent coating film so as not to affect the color of the pigment.

The water-dispersible resin may be any one of an anionic resin, a cationic resin, an amphoteric resin, and a nonionic resin. Considering the dispersion stability of the pigment in the aqueous ink, an anionic resin, an amphoteric resin, a nonionic resin, or a combination thereof can be preferably used, and the resin is more preferably an anionic resin. The water-dispersible resin is preferably an anionic resin having anionic functional groups such as carboxyl groups, sulfo groups, and phosphate groups.

The water-dispersible resin is preferably present as resin particles in the ink. From the viewpoint of the inkjet jetting characteristics, the average particle size of the resin particles is preferably not more than 300 nm, more preferably not more than 200 nm, and more preferably not more than 150 nm. The average particle size of the resin particles is preferably within a range from 10 nm to 300 nm. It is also preferable that the average particle size of the resin particles in the resin emulsion to be fed into the ink satisfies these ranges.

The average particle size of the resins refers to the volume-based average particle size, and is a numerical value measured by a dynamic light scattering method.

Examples of the water-dispersible resin include: conjugated diene resins such as styrene-butadiene copolymers, methyl methacrylate-butadiene copolymers, and vinyl chloride-vinyl acetate copolymers; acrylic-based resins such as polymers of acrylic acid esters and/or methacrylic acid esters, or copolymers thereof with styrene or the like; vinyl-based resins such as ethylene-vinyl acetate copolymers, or functional-group modified resins based on monomers containing functional groups such as carboxyl groups of these various resins; polyurethane resins such as polyether urethane resins, polyester urethane resins, polyester-ether urethane resins, and polycarbonate urethane resin; melamine resins; urea resins; polyester resins; polyolefin resins; silicone resins; polyvinyl butyral resins; and alkyd resins.

A resin emulsion containing one of these resins may be used, but a hybrid resin emulsion containing a combination of two or more of these resins may also be used. One resin may be used alone or a combination of two or more may be used.

The water-dispersible resin is preferably a water-dispersible urethane resin, a water-dispersible (meth)acrylic resin, a water-dispersible styrene (meth)acrylic resin, or a water-dispersible polyester resin, and more preferably a water-dispersible urethane resin or a water-dispersible polyester resin, and a combination thereof may be used.

Examples of the water-dispersible urethane resins include SUPERFLEX 300, SUPERFLEX 420, SUPERFLEX 460, SUPERFLEX 460S, SUPERFLEX 470, SUPERFLEX 740 (glass transition temperature—34° C.), and SUPERFLEX 150HS manufactured by DKS Co., Ltd.; DAOTAN TW 6490/35WA of DAICEL-ALLNEX LTD.; TAKELAC W-6061 manufactured by Mitsui Chemicals, Inc.; and UW-1701F manufactured by UBE Corporation (wherein all of the above are product names). These are anionic resins having a urethane backbone.

Examples of commercially available products of the water-dispersible (meth)acrylic resins or water-dispersible styrene (meth)acrylic resins include Mowinyl 6751D, Mowinyl 6960, Mowinyl 6963, Mowinyl 702, Mowinyl 8020, Mowinyl 966A, Mowinyl 6718, Mowinyl 6750, and Mowinyl 7720, manufactured by Nippon Synthetic Chemical Industry Co., Ltd., Joncryl PDX-7341 and Joncryl PDX-7370, manufactured by BASF Japan Ltd., and Neocryl A-1094 and Neocryl BT-62 manufactured by DSM Coating Resins, LLC (wherein all of the above are product names). Among these, a resin with a glass transition temperature of not more than 10° C. is preferred.

Examples of the water-dispersible polyester resins include Elitel KT-0507, Elitel KT-8701, Elitel KT-8803, Elitel KT-9204, Elitel KT-9511, Elitel KA-14495, and Elitel KA-50715 manufactured by UNITIKA LTD.; and VYLONAL MD-1100, VYLONAL MD-1200, VYLONAL MD-1245, VYLONAL MD-1335, VYLONAL MD-1480, VYLONAL MD-1500, VYLONAL MD-1930, VYLONAL MD-1985, and VYLONAL MD-2000 manufactured by TOYOBO CO., LTD. (wherein all of the above are product names).

One water-dispersible resin may be used alone or a combination of two or more may be used.

If the amount of the water-dispersible resin, expressed as the solid fraction amount, relative to the total amount of the ink is at least 1% by mass, at least 5% by mass, or at least 10% by mass, the fixation of the ink image of the printed textile item can be further enhanced. If the amount of the water-dispersible resin, expressed as the solid fraction amount, relative to the total amount of the ink is at least 10% by mass, at least 13% by mass, or at least 15% by mass, the coating film strength of the ink image of the printed textile item can be further enhanced, and the abrasion resistance and robustness of the printed textile item can be further improved. According to one embodiment, even if the aqueous ink contains a large amount of a solid fraction such as water-dispersible resin particles and the like, the aggregation of the resin particles and the like may be suppressed. This can prevent the deterioration in the ink wiping properties.

From the viewpoint of adjusting the viscosity of the ink, the amount of the water-dispersible resin, expressed as the solid fraction amount, relative to the total amount of the ink is preferably not more than 30% by mass, not more than 25% by mass, or not more than 20% by mass.

The amount of the water-dispersible resin, expressed as the solid fraction amount, relative to the total amount of the ink may be 5 to 30% by mass, 10 to 25% by mass, or 15 to 20% by mass, for example.

From the viewpoints of enhancing the fixation and coating film strength of the ink image and of adjusting the ink viscosity, the amount of the water-dispersible resin, expressed as a mass ratio relative to 1 part by mass for the pigment, is preferably 0.1 to 10 parts by mass, more preferably 1 to 5 parts by mass, and even more preferably 1.5 to 3 parts by mass.

The aqueous ink may further contain a crosslinking agent. When the aqueous ink contains a crosslinking agent, the coating film strength of the ink image can be further enhanced. Examples of the crosslinking agent include carbodiimide-based compounds, isocyanate-based compounds, and oxazoline-based compounds. The amount of the crosslinking agent relative to the total amount of the aqueous ink is preferably 0.1 to 5% by mass and more preferably 0.2 to 2% by mass.

The aqueous ink can further contain a surfactant. Examples of the surfactants that may be used include anionic surfactants, cationic surfactants, amphoteric surfactants, and nonionic surfactants, but nonionic surfactants are more preferred. The surfactant may be, for example, a low-molecular weight surfactant or a polymer-based surfactant.

The HLB value of the surfactant is preferably 5 to 20 and more preferably 10 to 18.

Examples of the nonionic surfactants include ester-based surfactants such as glycerol fatty acid esters and fatty acid sorbitan esters; ether-based surfactants such as polyoxyethylene alkyl ethers, polyoxyethylene alkylphenyl ethers, and polyoxypropylene alkyl ethers; ether ester-based surfactants such as polyoxyethylene sorbitan fatty acid esters; acetylene-based surfactants; silicone-based surfactants; and fluorine-based surfactants. Among these, acetylene-based surfactants such as acetylene glycol-based surfactants can be used particularly favorably.

Examples of the acetylene-based surfactants include acetylene glycol-based surfactants, acetylene alcohol-based surfactants, and surfactants having an acetylene group. Acetylene glycol-based surfactants are glycols having an acetylene group, are preferably glycols having a left-right symmetrical structure with an acetylene group in the center, and may include a structure in which ethylene oxide has been added to acetylene glycol. Examples of commercially available products of acetylene-based surfactants include the SURFYNOL series of products such as “SURFYNOL 104E”, “SURFYNOL 104H”, “SURFYNOL 420”, “SURFYNOL 440”, “SURF YNOL 465”, and “SURFYNOL 485” manufactured by Evonik Industries AG, and the OLFINE series of products such as “OLFINE E1004”, “OLFINE E1010”, and “OLFINE E1020” manufactured by Nissin Chemical Industry Co., Ltd. (wherein all of the above are product names).

Examples of the silicone-based surfactants include polyether-modified silicone-based surfactants, alkyl-aralkyl-comodified silicone-based surfactants, and acrylic silicone-based surfactants.

Examples of commercially available products of silicone-based surfactants include “SILFACE SAG002” and “SILFACE SAG503A” manufactured by Nissin Chemical Industry Co., Ltd. (wherein both of the above are product names).

Further examples of other nonionic surfactants include polyoxyethylene alkyl ether-based surfactants such as the EMULGEN series of products including “EMULGEN 102KG”, “EMULGEN 103”, “EMULGEN 104P”, “EMULGEN 105”, “EMULGEN 106”, “EMULGEN 108”, “EMULGEN 120”, “EMULGEN 147”, “EMULGEN 150”, “EMULGEN 220”, “EMULGEN 350”, “EMULGEN 404”, “EMULGEN 420”, “EMULGEN 705”, “EMULGEN 707”, “EMULGEN 709”, “EMULGEN 1108”, “EMULGEN 4085”, and “EMULGEN 2025G” manufactured by Kao Corporation (wherein all of the above are product names).

Examples of the anionic surfactants include the EMAL series of products such as “EMAL 0”, “EMAL 10”, “EMAL 2F”, “EMAL 40”, and “EMAL 20C”, the NEOPELEX series of products such as “NEOPELEX GS”, “NEOPELEX G-15”, “NEOPELEX G-25”, and “NEOPELEX G-65”, the PELEX series of products such as “PELEX OT-P”, “PELEX TR”, “PELEX CS”, “PELEX TA”, “PELEX SS-L”, and “PELEX SS-H”, and the DEMOL series of products such as “DEMOL N, DEMOL NL”, “DEMOL RN”, and “DEMOL MS”, all manufactured by Kao Corporation (wherein all of the above are product names).

Examples of the cationic surfactants include the ACETAMIN series of products such as “ACETAMIN 24” and “ACETAMIN 86”, the QUARTAMIN series of products such as “QUARTAMIN 24P”, “QUARTAMIN 86P”, “QUARTAMIN 60W”, and “QUARTAMIN 86W”, and the SANISOL series of products such as “SANISOL C” and “SANISOL B-50”, all manufactured by Kao Corporation (wherein all of the above are product names).

Examples of the amphoteric surfactants include the AMPHITOL series of products such as “AMPHITOL 20BS”, “AMPHITOL 24B”, “AMPHITOL 86B”, “AMPHITOL 20YB”, and “AMPHITOL 20N” manufactured by Kao Corporation (wherein all of the above are product names).

A single surfactant may be used, or a combination of two or more surfactants may be used.

The amount of the surfactant relative to the total amount of the ink is preferably 0.1 to 5% by mass and more preferably 0.2 to 2% by mass.

The aqueous ink may further contain one or more other components. Examples of these other components include pH adjusters, preservatives, rust inhibitors, and antifoaming agent.

There are no particular limitations on the method used for producing the aqueous ink, and production may be performed using appropriate conventional methods. For example, the aqueous ink may be obtained by using a stirring device such as a three-one motor to disperse all of the components, either in a single batch or in a number of separate batches, and then passing the resulting dispersion through a filtration device such as a membrane filter if desired.

From the viewpoint of the ink storage stability, the pH of the aqueous ink is preferably 7.0 to 10.0 and more preferably 7.5 to 9.0.

The viscosity of the aqueous ink may be adjusted as appropriate, and for example, from the viewpoint of the jetting characteristics, the viscosity at 23° C. is preferably 1 to 30 mPa·s.

It is possible to provide a printed textile item by applying the aqueous inkjet ink for textile printing according to one embodiment to the fabric. Examples of the fabric include woven fabrics, knitted fabrics, and non-woven fabrics.

Examples of fibers contained in the fabric include inorganic fibers such as metallic fibers, glass fibers, rock fibers, and slag fibers; recycled fibers such as cellulose-based and protein-based fibers; semi-synthetic fibers such as cellulose-based fibers; synthetic fibers such as polyamide, polyester, polyvinyl chloride, polyvinylidene chloride, polyacrylonitrile, polyvinyl alcohol, polyurethane, polyethylene, polypropylene, polystyrene, and polyfluoroethylene; and natural fibers such as cotton, hemp, silk, and wool. The fabric may contain at least one type of the fibers selected from among the above-described fibers.

### <Pretreatment Liquid>

The fabric to which an aqueous inkjet ink for textile printing is to be applied may be pre-treated or untreated. By using the pretreated fabric, the image quality of the ink image can be further enhanced and the fixation of the ink image to the fabric can be further enhanced. The pretreated fabric can be obtained by applying a pretreatment liquid to the fabric.

As the pretreatment liquid, a pretreatment liquid containing an aggregating agent and water can be preferably used.

As the aggregating agent, a component which has an action of causing the colorant within the ink to aggregate on top of the fabric may be used. As a result, if the ink is additionally applied to the fabric to which the pretreatment liquid has been applied, the colorant in the ink aggregates on top of the fabric, the image density can be further increased, and the bleeding of the image can be prevented. Specific examples of the aggregating agent include metal salts, cationic polymers, and organic acids, and one of these may be used or a combination of these substances may be used.

The total amount of the aggregating agent, expressed as the active component amount, relative to the total amount of the pretreatment liquid is preferably 1 to 30% by mass, more preferably 3 to 30% by mass, and even more preferably 5 to 15% by mass.

As the metal salts, polyvalent metal salts can be preferably used.

Polyvalent metal salts are composed of a divalent or higher polyvalent metal ion and an anion. Examples of the divalent or higher polyvalent metal ion include Ca²⁺, Mg²⁺, Cu²⁺, Ni²⁺, Zn²⁺, and Ba²⁺. Examples of the anion include Cl⁻, NO₃⁻, CH₃COO⁻, I⁻, Br⁻, and ClO₃⁻. Specific examples of the polyvalent metal salts include calcium chloride, calcium nitrate, magnesium nitrate, copper nitrate, calcium acetate, and magnesium acetate.

Cationic water-soluble resins are preferably used as the cationic polymers.

Examples of the cationic water-soluble resins include polyethyleneimine (PEI), polyvinylamine, polyallylamine and salts thereof, polyvinylpyridine, and copolymers of cationic acrylamide. More specifically, for example, polydiallyldimethylammonium chloride and/or the like may be used.

Examples of the organic acids include formic acid, acetic acid, propionic acid, butyric acid, isobutyric acid, valeric acid, isovaleric acid, oxalic acid, malonic acid, succinic acid, glutaric acid, maleic acid, fumaric acid, citraconic acid, itaconic acid, tricarballylic acid, glycolic acid, thioglycolic acid, lactic acid, malic acid, tartaric acid, citric acid, isocitric acid, gluconic acid, pyruvic acid, oxalacetic acid, diglycolic acid, benzoic acid, phthalic acid, mandelic acid, and salicylic acid.

The pretreatment liquid preferably contains water. The pretreatment liquid may contain a water-soluble organic solvent in addition to or instead of water. The details of water and the water-soluble organic solvent are as described above in relation to the aqueous ink. As the water-soluble organic solvent, for example, one of those described above in relation to the aqueous ink can be used alone or a combination of two or more of those described above in relation to the aqueous ink can be used.

The amount of water relative to the total amount of the pretreatment liquid is preferably 30 to 90% by mass, more preferably 40 to 85% by mass, and even more preferably 50 to 80% by mass.

The amount of the water-soluble organic solvent relative to the total amount of the pretreatment liquid is preferably 5 to 50% by mass, more preferably 10 to 40% by mass, and even more preferably 15 to 30% by mass.

The pretreatment liquid may further contain a surfactant. As the surfactant, for example, one of those described above in relation to the aqueous ink may be used alone or a combination of two or more of those described above in relation to the aqueous ink may be used. Among them, nonionic surfactants are preferred, acetylene-based surfactants are more preferred, and acetylene glycol-based surfactants are even more preferred.

The amount of the surfactant, expressed as the active component amount, relative to the total amount of the pretreatment liquid is preferably 0.1 to 10% by mass and more preferably 0.2 to 5% by mass.

The pretreatment liquid may further contain one or more other components. Examples of these other components include pH adjusters, preservatives, rust inhibitors, and antifoaming agents.

There are no particular limitations on the method used for producing the pretreatment liquid, and production may be performed using appropriate conventional methods. For example, the pretreatment liquid may be obtained by using a stirring device such as a three-one motor to disperse all of the components, either in a single batch or in a number of separate batches, and then passing the dispersion through a filtration device such as a membrane filter if desired.

### <Method for Producing Printed Textile Item>

In the following, a description will be given regarding a method for producing a printed textile item by using an aqueous inkjet ink for textile printing according to one embodiment.

In one example, a printed textile item can be produced using a method including applying the aqueous inkjet ink for textile printing according to one embodiment to fabric by means of an inkjet method. The pretreatment liquid may be applied to the fabric before the aqueous inkjet ink for textile printing is applied to the fabric.

One preferred example of the method for producing a printed textile item can include applying the pretreatment liquid to the fabric and applying the aqueous ink according to one embodiment, by means of an inkjet method, to the fabric to which the pretreatment liquid has been applied. In this example, it is preferable that both of the pretreatment liquid and the aqueous ink are applied to the fabric by means of an inkjet method.

Another preferred example of a method for producing a printed textile item can include applying the pretreatment liquid to the fabric, applying a aqueous ink containing a white pigment, by means of an inkjet method, to the fabric to which the pretreatment liquid has been applied, and applying a aqueous ink containing a non-white pigment, by means of an inkjet method, to the fabric to which the aqueous ink containing the white pigment has been applied. In this example, at least one of the aqueous ink containing the white pigment and the aqueous ink containing the non-white pigment is the aqueous ink according to one embodiment. In this example, it is preferable that all of the pretreatment liquid, the aqueous ink containing the white pigment, and the aqueous ink containing the non-white pigment are applied to the fabric by means of an inkjet method.

The inkjet method is a printing method that can be conducted without fabric contact, in a simple and on-demand manner, and enables free image formation. There are no particular limitations on the inkjet method, and any of a piezo method, electrostatic method, thermal method, and the like may be used. When an inkjet printing device is used, liquid droplets of the pretreatment liquid or ink are preferably jetted from the inkjet head based on a digital signal, with the jetted ink droplets being adhered to the fabric. The inkjet printing device may be either a serial or line head type.

Application of the pretreatment liquid to the fabric will be described below.

The area of the fabric to which the pretreatment liquid is applied may be an area having the same shape as the image formed by the aqueous ink, may be a broad area that includes the shape of the image formed by the aqueous ink, or may be the entire surface of the fabric. The application area for the pretreatment liquid, the application area for the aqueous ink, and the application area for the color ink preferably overlap at least partially.

As a method for applying the pretreatment liquid to the fabric, for example, the pretreatment liquid may be applied uniformly to the surface of the fabric by using a brush, roller, bar coater, air knife coater, spray, and the like. Alternatively, the pretreatment liquid may be printed on the image area by means of a printing method such as an inkjet printing method, a gravure printing method, or a flexographic printing method.

The application amount of the pretreatment liquid to the fabric is preferably 5 to 200 g/m², preferably 10 to 100 g/m², and more preferably 15 to 80 g/m².

Next, a description will be given regarding the application of the aqueous ink to the fabric to which the pretreatment liquid has been applied by means of the inkjet method.

The application area for the aqueous ink and the application area for the pretreatment liquid preferably overlap at least partially.

The amount of the aqueous ink applied to the fabric is not particularly limited but is preferably 1 to 100 g/m² and more preferably 5 to 50 g/m², for example.

Suppose that the aqueous ink is a white ink and is applied to the fabric as an underlayer of a non-white ink. In the above case, the area of the fabric to which the white ink is applied may be an area of the same shape as the image that is to be formed by the non-white ink, may be a broader area that incorporates the shape of the image to be formed by the non-white ink, or may be the entire surface of the fabric. When the underlayer is formed, the amount of the white ink applied to the fabric is not particularly limited but is preferably 80 to 400 g/m² and more preferably 120 to 250 g/m², for example.

After applying the pretreatment liquid to the fabric, the aqueous ink may be applied to the fabric by means of a wet-on-wet method, or the aqueous ink may be applied to the fabric after drying the fabric. In the wet-on-wet method, the aqueous ink is preferably applied in a state where the moisture has not been completely removed from the fabric to which the pretreatment liquid has been applied. It is preferable that the aqueous ink may be applied while the fabric to which the pretreatment liquid has been applied is maintained in a wet state. For example, following application of the pretreatment liquid to the fabric, the aqueous ink is preferably applied to the fabric without first conducting a drying step such as heated drying. Similarly, suppose that the non-white ink is applied to the fabric after applying the white ink to the fabric and forming an underlayer. In the above case also, the non-white ink may be applied to the fabric by means of the wet-on-wet method after applying the white ink to the fabric, or the non-white ink may be applied to the fabric after drying the fabric.

A step of subjecting the fabric to a heat treatment can be further provided after the application of the aqueous ink. This may allow the ink image to be more fixed.

The heat treatment temperature may be selected appropriately in accordance with the material of the fabric and the like. The heat treatment temperature is, for example, preferably at least 100° C. and more preferably at least 150° C. From the viewpoint of reducing any damage to the fabric, the heat treatment temperature is preferably not more than 200° C.

There are no particular limitations on the heating device, and for example, a heat press, roll heater, hot air device, infrared lamp heater, or the like may be used. The heat treatment time may be selected appropriately in accordance with the heating method and the like, and is, for example, preferably from 1 second to 10 minutes. The heat treatment time may be, for example, from 5 seconds to 5 minutes.

The application of the pretreatment liquid, the application of the white ink, and the application of the non-white ink may be performed by using separate printing devices or by using a single printing device. For example, two printing devices may be used, the application of the pretreatment liquid may be performed by using one of the printing devices, and the application of the white ink and the application of the non-white ink may be performed by using the other of the printing devices.

An overcoat layer may be formed on the fabric after the application of the aqueous ink. The overcoat layer can be formed by applying a post-treatment liquid to the fabric after the application of the ink. As the post-treatment liquid, for example, a post-treatment liquid containing a resin capable of forming a coating film and an aqueous or oil-based medium can be used. Following the application of the aqueous ink, heating the fabric may be provided, followed by the application of the post-treatment liquid. The post-treatment liquid may also be applied by means of the wet-on-wet method following the application of the aqueous ink. Further, heating of the fabric may also be provided after the application of the post-treatment liquid.

### <Ink Set>

According to one embodiment, it is possible to provide an ink set containing an aqueous inkjet ink for textile printing and a pretreatment liquid. The aqueous inkjet ink for textile printing may be a combination of an aqueous ink containing a white pigment and an aqueous ink containing a non-white pigment. These ink sets may further contain a post-treatment liquid. Details of the aqueous inkjet ink for textile printing and the pretreatment liquid are as described above.

### EXAMPLES

The present invention will be described below in further detail using examples. The present invention is not limited to the examples below. In the following description, “%” represents “% by mass” unless specifically stated otherwise. Raw materials for which no particular explanation is given regarding the manufacturing source are available from FUJIFILM Wako Pure Chemical Corporation and the like.

“Production of White Pigment Dispersion”

First, 400 g of titanium oxide “TIPAQUE R-980” (product name, manufactured by ISHIHARA SANGYO KAISHA, LTD.) as a white pigment, and 16 g (active component: 4 g) of “DEMOL P” (product name, manufactured by Kao Corporation) as a pigment dispersant were mixed with 584 g of ion-exchanged water, and a bead mill (“DYNO-MILL KDL model A” manufactured by Shinmaru Enterprises Corporation (product name)) containing 0.5 mmø zirconia beads at a fill ratio of 80% by volume was used to disperse the mixture under conditions including a residence time of 2 minutes, thus obtaining a white pigment dispersion (pigment fraction: 40%, solid fraction: 41.6%).

“Production of Black Pigment Dispersion”

First, 300 g of carbon black “MOGUL L” (produce name, manufactured by CABOT SPECIALTY CHEMICALS, INC.) as a black pigment and 90 g of “Borch (registered trademark) Gen DFN” (produce name, manufactured by Borchers SAS) as a pigment dispersant were mixed with 610 g of ion-exchanged water, and a bead mill (“DYNO-MILL KDL model A” manufactured by Shinmaru Enterprises Corporation (product name)) containing 0.5 mmø zirconia beads at a fill ratio of 85% by volume was used to disperse the mixture under conditions including a residence time of 9 minutes, thus obtaining a black pigment dispersion (pigment fraction: 30%, solid fraction: 39%).

“Production of Pigment Inks”

Tables 1 to 3 show the ink formulations and evaluation results. The raw materials were mixed according to the formulations shown in the tables and the obtained mixture was stirred at 100 rpm for 20 minutes using a mix rotor to obtain a pigment ink. In the tables, the amounts of the pigment dispersion and the resin emulsion are expressed as the total amount including the aqueous medium and the like. In Tables 1 to 3, Ex 1 to Ex 11 respectively represent Example 1 to Example 11, and C Ex 1 to C Ex 7 respectively represent Comparative Example 1 to Comparative Example 7.

The components used were as follows.

White pigment dispersion (pigment fraction: 40%): produced according to the above formulation.

Black pigment dispersion (pigment fraction: 30%): produced according to the above formulation.

Resin emulsion, “SUPERFLEX 470” (product name): carbonate-based urethane resin emulsion, resin fraction: 38%

Resin emulsion “Elitel KT-9204” (product name): polyester resin emulsion, resin fraction: 30%

Surfactant “OLFINE E1010” (product name) (boiling point: 418° C.): manufactured by Nissin Chemical Industry Co., Ltd., acetylene glycol-based surfactant, active component amount: 100% by mass

Water-soluble organic solvents: diethylene glycol (boiling point 244° C.), 1,3-butanediol (boiling point 207° C.), 3-methyl-1,3-butanediol (boiling point 203° C.), 2-ethyl-1,3-hexanediol (boiling point 245° C.); water-soluble organic solvents (A): glycerol (boiling point 290° C.), triethylene glycol (boiling point 288° C.); and amine compounds: 2,2′,2″-nitrilotriethanol (boiling point 360° C.), di-2-propanolamine (boiling point 249° C.), 2-dimethylethanolamine (boiling point 139° C.), triethylamine (boiling point 90° C.), 2-amino-2-methyl-1-propanol (boiling point 165° C.) are available from FUJIFILM Wako Pure Chemical Corporation.

“Water-soluble organic solvent (A)/water-soluble organic solvent (mass ratio)” shown in the table is calculated from the mass ratio of the amount of the water-soluble organic solvent (A) when the amount obtained by excluding the total amount of amine compound from the total amount of the water-soluble organic solvent is 1 part by mass.

“Amine compound/solid fraction (mass ratio)” shown in the table is calculated from the mass ratio of the amount of amine compound when the total amount of solid fraction is 1 part by mass.

The amount of the amine compound is the amount of an amino alcohol or an alkylamine.

The following evaluations were performed using each ink. The evaluation results are shown in each table.

“Ink Wiping Properties”

By using each ink and an inkjet printer manufactured by Mastermind Inc. “MMP-8130” (product name), an A4 size 100% solid image was printed 10 times consecutively on a black cotton T-shirt manufactured by Toms Co., Ltd. (product name: Printstar) which had been cut to A4 size, after leaving the obtained product for one day, a wiping operation was performed, and the number of nozzles that were jetting in a normal manner was measured by means of a nozzle check in the printer settings. From the ratio of the number of nozzles jetting the ink in a normal manner relative to the number of all nozzles, the wiping properties of the ink was evaluated based on the following criteria.

A: At least 90%

B: At least 70% and less than 90%

C: Less than 70%

“Preventing Solvent Bleeding of Printed Textile Item”

By using an inkjet printer manufactured by Mastermind Inc. “MMP-8130” (product name), a 100% solid image was printed on a black cotton T-shirt manufactured by Toms Co., Ltd. (product name: Printstar) which had been cut to A4 size, and the obtained product was heat pressed at 160° C. for 2 minutes, and accordingly a printed textile item was obtained. An A4 copy paper was adhered on the back side of the printed textile item and left for 1 day, and exudation on the paper was evaluated according to the following criteria. In this way, solvent bleeding of the printed textile item was evaluated.

A: No exudation occurs on the paper.

B: Exudation occurs on the paper, but the solvent does not adhere to a person's hand when the person touches the paper with his/her hand.

C: Exudation occurs on the paper, and the solvent adheres to a person's hand when the person touches the paper with his/her hand.

TABLE 1
Ink formulation and evaluation result

| | Units: % by mass | Ex 1 | Ex 2 | Ex 3 | Ex 4 | Ex 5 | Ex 6 |
|---|---|---|---|---|---|---|---|
| Pigment | White pigment- | 25.00 | 25.00 | 25.00 | 25.00 | 25.00 | 25.00 |
| dispersion | dispersion | | | | | | |
| | (pigment fraction: 40%, | | | | | | |
| | solid fraction: 41.6%) | | | | | | |
| | Black pigment- | — | — | — | — | — | — |
| | dispersion | | | | | | |
| | (pigment fraction: 30%, | | | | | | |
| | solid fraction: 39%) | | | | | | |
| Resin | SUPERFLEX 470 | 39.47 | — | 39.47 | 39.47 | 39.47 | 39.47 |
| emulsion | (resin fraction: 38%) | | | | | | |
| | Elitel KT-9204 | — | 50.00 | — | — | — | — |
| | (resin fraction: 30%) | | | | | | |
| Water- | Diethylene glycol | 15.00 | 15.00 | 15.00 | 15.00 | 15.00 | 23.00 |
| soluble | (boiling point: 244° C.) | | | | | | |
| organic | 1,3-butanediol | — | — | — | — | — | — |
| solvent | (boiling point: 207° C.) | | | | | | |
| | 3-methyl-1,3-butanediol | — | — | — | — | — | — |
| | (boiling point: 203° C.) | | | | | | |
| | 2-ethyl-1,3-hexanediol | — | — | — | — | — | — |
| | (boiling point: 245° C.) | | | | | | |
| Water- | Glycerol | 3.00 | 3.00 | 3.00 | 3.00 | 7.00 | 3.00 |
| soluble | (boiling point: 290° C.) | | | | | | |
| organic | Triethylene glycol | — | — | — | — | — | — |
| solvent | (boiling point: 288° C.) | | | | | | |
| (A) | | | | | | | |
| Surfactant | OLFINE E1010 | 0.70 | 0.70 | 0.70 | 0.70 | 0.70 | 0.70 |
| | (active component: | | | | | | |
| | 100%, boiling point: | | | | | | |
| | 418° C.) | | | | | | |
| Amine | 2,2′,2″-nitrilotriethanol | 1.00 | 1.00 | 2.00 | 0.25 | 1.00 | 1.00 |
| compound | (boiling point: 360° C.) | | | | | | |
| | Di-2-propanolamine | — | — | — | — | — | — |
| | (boiling point: 249° C.) | | | | | | |
| | 2-dimethylethanolamine | — | — | — | — | — | — |
| | (boiling point: 139° C.) | | | | | | |
| | Triethylamine | — | — | — | — | — | — |
| | (boiling point: 90° C.) | | | | | | |
| | 2-amino-2-methyl-1- | — | — | — | — | — | — |
| | propanol | | | | | | |
| | (boiling point: 165° C.) | | | | | | |
| Water | Ion-exchanged water | 15.83 | 5.30 | 14.83 | 16.58 | 11.83 | 5.83 |

| | | | | | | |
|---|---|---|---|---|---|---|
| Total (% by mass) | 100.00 | 100.00 | 100.00 | 100.00 | 100.00 | 100.00 |
| Solid fraction (% by mass) | 25.40 | 25.40 | 25.40 | 25.40 | 25.40 | 25.40 |
| Water-soluble organic solvent (A)/ | 0.167 | 0.167 | 0.167 | 0.167 | 0.318 | 0.115 |
| water-soluble organic solvent | | | | | | |
| (mass ratio) | | | | | | |
| Amine compound/solid fraction | 0.039 | 0.039 | 0.079 | 0.010 | 0.039 | 0.039 |
| (mass ratio) | | | | | | |
| Ink wiping properties | A | A | A | B | A | B |
| Prevention of solvent bleeding of | A | A | A | A | B | A |
| printed textile-item | | | | | | |

TABLE 2
Ink formulation and evaluation result

| | Units: % by mass | Ex 7 | Ex 8 | Ex 9 | Ex 10 | Ex 11 |
|---|---|---|---|---|---|---|
| Pigmen | White pigment dispersion | 25.00 | 25.00 | 25.00 | — | 18.75 |
| dispersion | (pigment fraction: 40%, | | | | | |
| | solid fraction: 41.6%) | | | | | |
| | Black pigment dispersion | — | — | — | 33.33 | — |
| | (pigment fraction: 30%, | | | | | |
| | solid fraction: 39%) | | | | | |
| Resin | SUPERFLEX 470 | 39.47 | 39.47 | 39.47 | 39.47 | 34.21 |
| emulsion | (resin fraction: 38%) | | | | | |
| | Elitel KT-9204 | — | — | — | — | — |
| | (resin fraction: 30%) | | | | | |
| Water- | Diethylene glycol | 15.00 | 15.00 | 15.00 | 15.00 | — |
| soluble | (boiling point: 244° C.) | | | | | |
| organic | 1,3-butanediol | — | — | — | — | 10.71 |
| solvent | (boiling point: 207° C.) | | | | | |
| | 3-methyl-1,3-butanediol | — | — | — | — | 3.43 |
| | (boiling point: 203° C.) | | | | | |
| | 2-ethyl-1,3-hexanediol | — | — | — | — | 0.86 |
| | (boiling point: 245° C.) | | | | | |
| Water- | Glycerol | — | 3.00 | 3.00 | 3.00 | 4.00 |
| soluble | (boiling point: 290° C.) | | | | | |
| organic | Triethylene glycol | 3.00 | — | — | — | — |
| solvent (A) | (boiling point: 288° C.) | | | | | |
| Surfactant | OLFINE E1010 | 0.70 | 0.70 | 0.70 | 0.70 | 0.70 |
| | (active component: 100%, boiling- | | | | | |
| | point: 418° C.) | | | | | |
| Amine | 2,2′,2″-nitrilotriethanol | 1.00 | — | — | 1.00 | — |
| compound | (boiling point: 360° C.) | | | | | |
| | Di-2-propanolamine | — | 1.00 | — | — | — |
| | (boiling point: 249° C.) | | | | | |
| | 2-dimethylethanolamine | — | — | 1.00 | — | — |
| | (boiling point: 139° C.) | | | | | |
| | Triethylamine | — | — | — | — | — |
| | (boiling point: 90° C.) | | | | | |
| | 2-amino-2-methyl-1-propanol | — | — | — | — | 1.00 |
| | (boiling point: 165° C.) | | | | | |
| Water | Ion-exchanged water | 15.83 | 15.83 | 15.83 | 7.49 | 26.34 |

| | | | | | |
|---|---|---|---|---|---|
| Total (% by mass) | 100.00 | 100.00 | 100.00 | 100.00 | 100.00 |
| Solid fraction (% by mass) | 25.40 | 25.40 | 25.40 | 27.87 | 20.80 |
| Water-soluble organic solvent (A)/water- | 0.167 | 0.167 | 0.167 | 0.167 | 0.211 |
| soluble organic solvent (mass ratio) | | | | | |
| Amine compound/solid fraction (mass ratio) | 0.039 | 0.039 | 0.039 | 0.036 | 0.048 |
| Ink wiping properties | A | A | B | A | A |
| Prevention of solvent bleeding of printed | A | A | A | A | A |
| textile item | | | | | |

TABLE 3
Ink formulation and evaluation result

| | Units: % by mass | C Ex 1 | C Ex 2 | C Ex 3 | C Ex 4 | C Ex 5 | C Ex 6 | C Ex 7 |
|---|---|---|---|---|---|---|---|---|
| Pigment | White pigment dispersion | 25.00 | 25.00 | 25.00 | 25.00 | 25.00 | 25.00 | 18.75 |
| dispersion | (pigment fraction: 40%, | | | | | | | |
| | solid fraction: 41.6%) | | | | | | | |
| | Black pigment dispersion | — | — | — | — | — | — | — |
| | (pigment fraction: 30%, | | | | | | | |
| | solid fraction: 39%) | | | | | | | |
| Resin | SUPERFLEX 470 | 39.47 | 39.47 | 39.47 | 39.47 | 39.47 | 39.47 | 34.21 |
| emulsion | (resin fraction: 38%) | | | | | | | |
| | Elitel KT-9204 | — | — | — | — | — | — | — |
| | (resin fraction: 30%) | | | | | | | |
| Water- | Diethylene glycol | 15.00 | 15.00 | 15.00 | 15.00 | 15.00 | 26.00 | — |
| soluble | (boiling point: 244° C.) | | | | | | | |
| organic | 1,3-butanediol | — | — | — | — | — | — | 25.00 |
| solvent | (boiling point: 207° C.) | | | | | | | |
| | 3-methyl-1,3-butanediol | — | — | — | — | — | — | 8.00 |
| | (boiling point: 203° C.) | | | | | | | |
| | 2-ethyl-1,3-hexanediol | — | — | — | — | — | — | 2.00 |
| | (boiling point: 245° C.) | | | | | | | |
| Water- | Glycerol | 3.00 | 3.00 | 3.00 | — | 10.00 | 3.00 | 4.00 |
| soluble | (boiling point: 290° C.) | | | | | | | |
| organic | Triethylene glycol | — | — | — | — | — | — | — |
| solvent (A) | (boiling point: 288° C.) | | | | | | | |
| Surfactant | OLFINE E1010 | 0.70 | 0.70 | 0.70 | 0.70 | 0.70 | 0.70 | 0.70 |
| | (active component: 100%, | | | | | | | |
| | boiling point: 418° C.) | | | | | | | |
| Amine | 2,2′,2″-nitrilotriethanol | — | 0.13 | — | 1.00 | 1.00 | 1.00 | — |
| compound | (boiling point: 360° C.) | | | | | | | |
| | Di-2-propanolamine | — | — | — | — | — | — | — |
| | (boiling point: 249° C.) | | | | | | | |
| | 2-dimethylethanolamine | — | — | — | — | — | — | — |
| | (boiling point: 139° C.) | | | | | | | |
| | Triethylamine | — | — | 1.00 | — | — | — | — |
| | (boiling point: 90° C.) | | | | | | | |
| | 2-amino-2-methyl-1- | — | — | — | — | — | — | 1.00 |
| | propanol | | | | | | | |
| | (boiling point: 165° C.) | | | | | | | |
| Water | Ion-exchanged water | 16.83 | 16.70 | 15.83 | 18.83 | 8.83 | 4.83 | 6.34 |

| | | | | | | | |
|---|---|---|---|---|---|---|---|
| Total (% by mass) | 100.00 | 100.00 | 100.00 | 100.00 | 100.00 | 100.00 | 100.00 |
| Solid fraction (% by mass) | 25.40 | 25.40 | 25.40 | 25.40 | 25.40 | 25.40 | 20.80 |
| Water-soluble organic solvent (A)/ | 0.167 | 0.167 | 0.167 | — | 0.400 | 0.103 | 0.103 |
| water-soluble organic solvent | | | | | | | |
| (mass ratio) | | | | | | | |
| Amine compound/solid fraction | — | 0.005 | 0.039 | 0.039 | 0.039 | 0.039 | 0.048 |
| (mass ratio) | | | | | | | |
| Ink wiping properties | C | C | C | C | A | C | C |
| Prevention of solvent bleeding of | A | A | A | A | C | A | A |
| printed textile item | | | | | | | |

As shown in the tables, it can be observed that the ink of each of the Examples has excellent wiping properties and can prevent solvent bleeding of the obtained printed textile item. In addition, the ink of each of the Examples exhibited a viscosity suitable for the inkjet ink, and the image quality of the printed textile item was also good.

In Comparative Example 1, no amino alcohol was contained. In Comparative Example 2, the mass ratio of amino alcohol was small. In Comparative Example 3, alkylamine was used. In Comparative Example 4, no water-soluble organic solvent (A) was contained. In these comparative examples, the ink wiping properties decreased. In Comparative Example 5, the mass ratio of the water-soluble organic solvent (A) was large and solvent bleeding of the printed textile item occurred. In Comparative Examples 6 and 7, the mass ratio of the water-soluble organic solvent (A) was small and the ink wiping properties decreased.

It is to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. An aqueous inkjet ink for textile printing comprising water, a water-soluble organic solvent, an amino alcohol, a water-dispersible resin, and a pigment, wherein
an amount of a solid fraction of the ink relative to a total mass of the ink is at least 20% by mass,
the water-soluble organic solvent contains a water-soluble organic solvent (A) which has a boiling point of at least 250° C. and is one or more compounds selected from the group consisting of polyalkylene glycols, polyalkylene glycol derivatives, and trihydric alcohols,
an amount of the water-soluble organic solvent (A) relative to the total amount of the ink is 1 to 7% by mass,
if an amount obtained by excluding an amount of the amino alcohol from a total amount of the water-soluble organic solvent is 1 part by mass, an amount of the water-soluble organic solvent (A) is at least 0.110 parts by mass, and
if a total amount of the solid fraction of the ink is 1 part by mass, an amount of the amino alcohol is at least 0.010 parts by mass.

2. The aqueous inkjet ink for textile printing according to claim 1, wherein
if the amount obtained by excluding the amount of the amino alcohol from the total amount of the water-soluble organic solvent is 1 part by mass, the amount of the water-soluble organic solvent (A) is at least 0.150 parts by mass.

3. The aqueous inkjet ink for textile printing according to claim 1, wherein
if the total amount of the solid fraction of the ink is 1 part by mass, the amount of the amino alcohol is at least 0.030 parts by mass.

4. The aqueous inkjet ink for textile printing according to claim 1, wherein
the water-soluble organic solvent contains a water-soluble organic solvent (B) having a boiling point of less than 250° C., and
if the amount obtained by excluding the amount of the amino alcohol from the total amount of the water-soluble organic solvent is 1 part by mass, an amount of the water-soluble organic solvent (B) is at least 0.500 parts by mass.

5. A method for producing a printed textile item comprising:
applying the aqueous inkjet ink for textile printing according to claim 1 to a fabric by means of an inkjet method.

6. The method for producing a printed textile item according to claim 5, wherein
in the aqueous inkjet ink for textile printing, if the amount obtained by excluding the amount of the amino alcohol from the total amount of the water-soluble organic solvent is 1 part by mass, the amount of the water-soluble organic solvent (A) is at least 0.150 parts by mass.

7. The method for producing a printed textile item according to claim 5, wherein
in the aqueous inkjet ink for textile printing, if the total amount of the solid fraction of the ink is 1 part by mass, the amount of the amino alcohol is at least 0.030 parts by mass.

8. The method for producing a printed textile item according to claim 5, wherein
in the aqueous inkjet ink for textile printing, the water-soluble organic solvent contains a water-soluble organic solvent (B) having a boiling point of less than 250° C., and
in the aqueous inkjet ink for textile printing, if the amount obtained by excluding the amount of the amino alcohol from the total amount of the water-soluble organic solvent is 1 part by mass, an amount of the water-soluble organic solvent (B) is at least 0.500 parts by mass.
